(19) United States
(12) Patent Application Publication
(10) Pub. No.: US 2015/0067014 A1
(43) Pub. Date: Mar. 5, 2015

(54) COMPUTER SYSTEM AND CONTROL METHOD OF COMPUTER SYSTEM

(71) Applicant: HITACHI, LTD., Tokyo (JP)

(72) Inventors: Etsutaro Akagawa, Tokyo (JP); Wataru Okada, Tokyo (JP); Hirotaka Nakagawa, Tokyo (JP)

(21) Appl. No.: 14/356,777

(22) PCT Filed: Sep. 5, 2013
(86) PCT No.: PCT/JP2013/073864

§ 371 Date: May 7, 2014

(51) Int. Cl. H04L 29/08

(52) U.S. Cl. CPC H04L 67/10
USPC 709/201

(57) ABSTRACT

A computer system includes a plurality of processing computers which switches an execution time of a main function processing and a management function processing in a given time, and a management computer which has a schedule table showing a schedule in which each processing computer may execute the management function processing, and which is capable of instructing the execution of the management function processing to each processing computer, wherein the processing computer notifies a start time an end time of the management function processing to the management computer before starting the management function processing, and the management computer updates the schedule table with the notification, an decides the processing computer that may execute the management function processing, by referring to the schedule table, upon instructing the management function processing to the processing computer.

### TECHNICAL FIELD

The present invention relates to a technique for improving performance of a management computer in a distributed processing technique.

### BACKGROUND ART

Recently, a distributed processing technique of processing computing with high-speed, by disposing a plurality of computers in parallel, is becoming popular. In the distributed processing technique, a technique of deciding the computer which executes the computing is important, and, for example in PTL1, a technique of calculating a combination in which a communication load between a device stored with data as a target of the processing and a computer which executes the computing becomes minimum, in order to decide the computer which executes the computing, is disclosed.

### CITATION LIST

### Patent Literature

[PTL 1] WO2011/074699

### SUMMARY OF INVENTION

### Technical Problem

In the conventional technique, it is necessary for a management computer to decide the computer which executes the computing, by obtaining a connecting relationship of an arrangement of all the data that must be processed and all of the processing computers or communication load thereof. Therefore, a problem is that a high specification is required for the management computer.

One of the aims of the present invention is, in view of the above-mentioned problem, to provide a computer system which decides the processing computer which executes the computing effectively, and a control method thereof.

### Solution to Problem

Of the inventions disclosed in the present application, a representative example will be explained below.

A computer in a representative embodiment of the present invention is a computer system including a plurality of processing computers that switch an execution time of a main function processing and a management function processing in a given time period, and a management computer which has a schedule table showing a schedule in which each processing computer may execute the management function processing, and which is capable of instructing the execution of the management function processing to each processing computer, wherein the processing computer notifies a start time and an end time of the management function processing to the management computer before starting the management function processing, and the management computer updates the schedule table with the notification, and decides the processing computer that may execute the management function processing, by referring to the schedule table, upon instructing the management function processing to the processing computer.

### Advantageous Effects of Invention

According to the present invention, an advantageous effect that the processing computer is capable of executing the management function processing, even when receiving a management request during a main function processing time, and the management computer is not required to strictly manage the schedule of the processing computer, so that the specification of the resource requested to the management computer may be suppressed low, may be obtained.

### BRIEF DESCRIPTION OF DRAWINGS

FIG. 1 is a block configuration diagram illustrating an outline of an embodiment.

FIG. 2 is a block diagram illustrating a configuration of a computer in Embodiment 1 through Embodiment 3.

FIG. 3 is a block diagram illustrating an example of a management function schedule table in Embodiment 1.

FIG. 4 is a block diagram illustrating an example of a result wait queue in Embodiment 1 through Embodiment 3.

FIG. 5 is a block diagram illustrating a management request queue in Embodiment 1 through Embodiment 3.

FIG. 6 is a block diagram illustrating a time-sharing processing mode of a processing computer in Embodiment 1.

FIG. 7 is a flowchart illustrating a procedure, in Embodiment 1, in which management computer updates the management function schedule table, based on a notification from the processing computer.

FIG. 8 is a flowchart illustrating a procedure, in Embodiment 1, in which the processing computer which received a request for a management function processing from the management computer receives the request and registers the same to the management request queue in a shared computer.

FIG. 9 is a flowchart illustrating a procedure, in Embodiment 1, in which the processing computer executes the management function processing which is registered in the management request queue in the shared computer.

FIG. 10 is a block diagram illustrating a time-sharing processing mode of the processing computer in Embodiment 2.

FIG. 11 is a block diagram illustrating an example of the management function schedule table in Embodiment 2.

FIG. 12 is a flowchart illustrating a procedure, in Embodiment 2, in which the management computer updates the management function schedule table, based on the notification from the processing computer.

FIG. 13 is a flowchart illustrating a procedure, in Embodiment 2, in which the management computer transmits the request for the management function processing to the processing computer.

FIG. 14 is a flowchart illustrating a procedure, in Embodiment 3, in which the management computer transmits the request for the management function processing to the processing computer under the configuration of Embodiment 1.

FIG. 15 is a flowchart illustrating a procedure, in Embodiment 3, in which the management computer transmits the request for the management function processing to the processing computer under the configuration in Embodiment 2.

FIG. 16 is a flowchart illustrating a procedure, in Embodiment 3, in which the processing computer executes the management function processing.

### DESCRIPTION OF EMBODIMENTS

Hereinafter, as modes for carrying out the present invention, Embodiment 1 through Embodiment 3 will be explained with reference to the drawings.

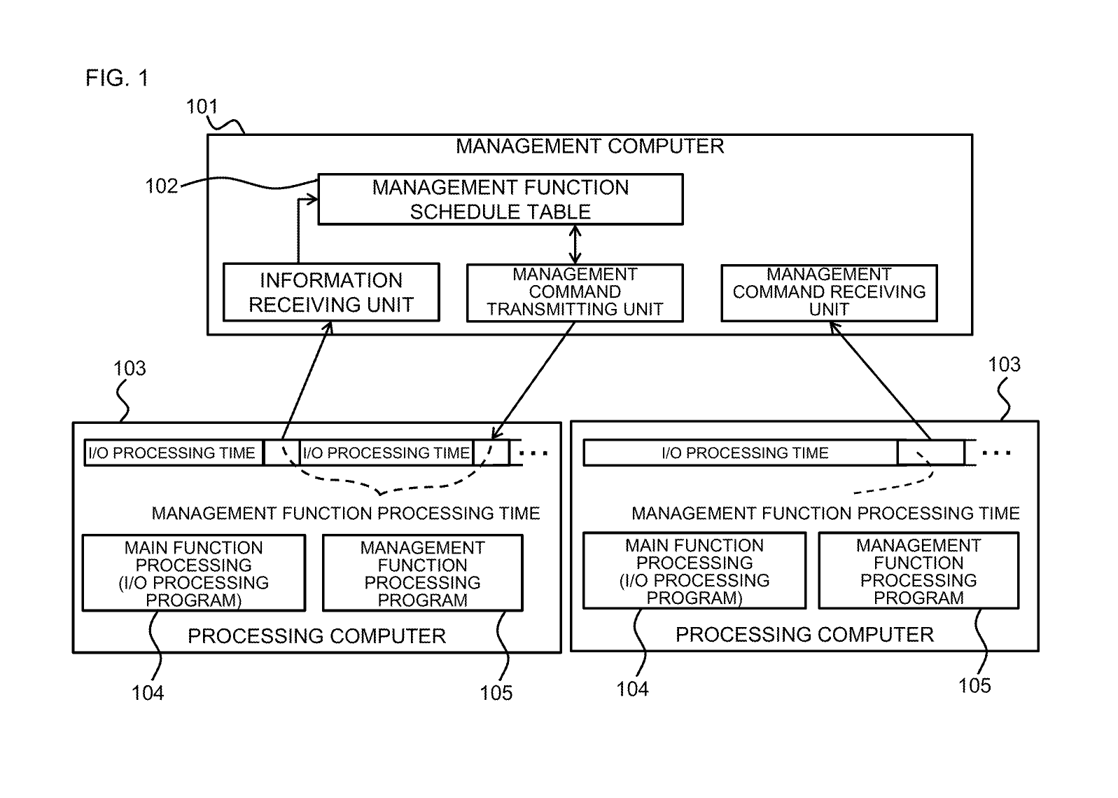

As a start, explanation will be given on an outline of a basic function related to each Embodiment, using a block configuration diagram shown in FIG. 1.

A processing computer 103 alternatively executes by time-sharing, a main function processing (I/O processing) program 104 which executes a main function processing (herein, an I/O processing is selected as a representative processing), and a management function processing program 105 which executes a management function processing (for example, a processing of changing a configuration of the processing computer 103 and the like). A management computer 101 includes a table 102 (hereinafter referred to as “management function schedule table 102”) which manages a time (a schedule) when the management function processing program 105 that a plurality of the processing computers 103 each has is operating.

The main function processing (I/O processing) program 104 determines, when the main function processing (the I/O processing) ends, whether or not the program to be executed next is the management function processing program 105. If the program to be executed next is the management function processing program 105, then the main function processing (I/O processing) program 104 notifies a start time and an end time of the operation of the management function processing program 105 to the management computer 101. The management computer 101 receiving the notice updates the management function schedule table 102 according to the content of the notification.

When the management computer 101 receives a request for the management function processing from an administrator, the management computer 101 refers to the management function schedule table 102, and transmits the request for the management function processing to the processing computer 103 in which the management function processing program 105 is operating at a current time. The processing computer 103 receiving the request executes the management function processing, if the management function processing program 105 is operating at the time of receipt, and executes the management function processing when the management function processing program 105 is operated next if the management function processing program 105 is not currently operating.

Since it is not necessary for the management computer to strictly manage the schedule of the processing computer, the present invention is preferable specifically in a system configured to have a large number of the processing computers, in an environment where the management computer with sufficient performance for managing the processing schedule of all processing computers is not provided.

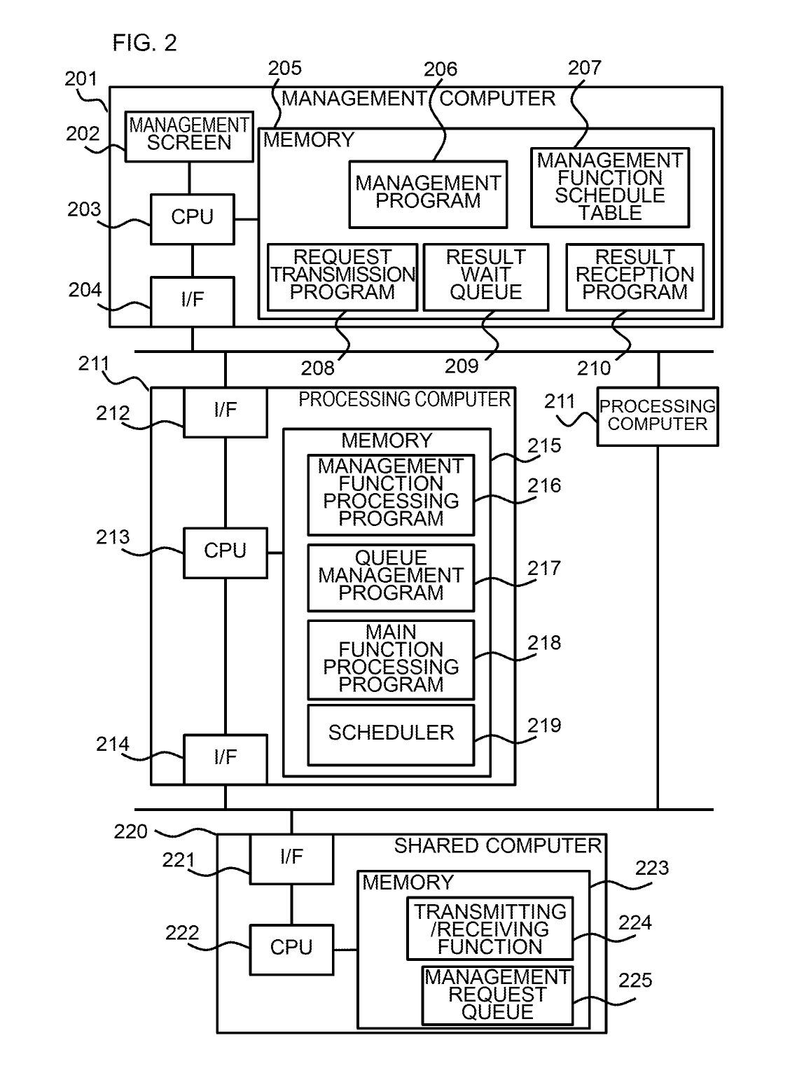

FIG. 2 is a block diagram illustrating a configuration of a computer system in Embodiment 1 through Embodiment 3.

Before starting explanation of each constituent element, correspondence with the block configuration diagram in FIG. 1 will be explained. The management computer 101, the management function schedule table 102, the processing computer 103, the main function processing (I/O processing) program 104 and the management function processing program 105 in FIG. 1 respectively corresponds in series to a management computer 201, a management function schedule table 207, a processing computer 211, a main function processing program 218 and a management function processing program 216 of FIG. 2.

The management computer 201 is configured from a management screen 202 for a user to manipulate the management computer 201, a CPU 203, an interface 204 for connecting with the processing computer 211, and a memory 205.

The memory 205 is configured from a management program 206 which executes each program on the memory 205, according to the manipulation content of the user from the management screen 202, the management function schedule table 207 which stores the schedule of the management function processing in each processing computer 211, a request transmission program 208 which transmits the request for the management function processing to the processing computer 211, a request wait queue 209 for waiting the management function processing requested by the request transmission program 208, and a result reception program 210 for receiving the processing result. Further, other program, not shown, for manipulating the result wait queue 209 is stored in the memory 205.

In the following embodiments, a processing of the management computer 201 activating the program and manipulating the result wait queue 209 using the CPU 203 may sometimes be referred simply to as “the management computer 201 manipulates the result wait queue 209”. Further, a program, not shown, for communicating with the processing computer 211 is stored to the memory 205. A processing of the management computer 201 activating this program and communicating with the processing computer 211 using the CPU 203 may sometimes be referred simply to as “the management computer 201 communicates with the processing computer 211”.

The processing computer 211 is configured from an interface 212 for connecting with the management computer 201, a CPU 213, an interface 214 for connecting with a shared computer 220, and a memory 215.

The memory 215 is configured from the management function processing program 216 for processing the management function, a queue management program 217 for manipulating a management request queue 225 that the shared computer 220 has, the main function processing program 218 for processing the main function, such as the I/O processing explained above, and a scheduler 219 which manages the execution time of all the programs. The computer system in each embodiment is configured from one or more processing computers 211.

The shared computer 220 is configured from an interface 221 for connecting with the processing computer 211, a CPU 222, and a memory 223.

The memory 223 is configured from a transmitting/receiving function 224 for communicating with the processing computer 211, and the management request queue 225 for storing a management request issued by the management computer 201. Further, the memory 223 is stored with a program, not shown, for manipulating the management request queue 225. In the following embodiments, a processing of the shared computer 220 activating this program and manipulating the management request queue 225 using the CPU 222 may sometimes be referred simply to as “the shared computer 220 manipulates the management request queue 225”.

As a network which connects the management computer 201, the processing computer 211 and the shared computer 220, a Local Area Network (hereinafter referred to as “LAN”), or a Storage Area Network (hereinafter referred to as “SAN”) are suitably used.

In the following embodiments, as is shown in FIG. 2, explanation will be given on a computer system configured from a plurality of computers. However, the processing realized by these computers may be realized in one computer. In such case, the management computer 201 is to be read as a Baseboard Management Controller (hereinafter referred to as “BMC”) in the one computer, the processing computer 211 is to be read as a microprocessor, and the shared computer 220 is to be read as a shared memory which is shared by all of the microprocessors. Further, as a network which connects the BMC, the microprocessor, and the shared memory, the LAN or a PCI Express (registered trademark) are suitably used.

### Embodiment 1

Embodiment 1 is an embodiment in which the management computer 201 decides the processing computer 211 which executes the management function processing, taking into consideration the schedule of the processing executed by each processing computer 211, and receives the result of the management function processing.

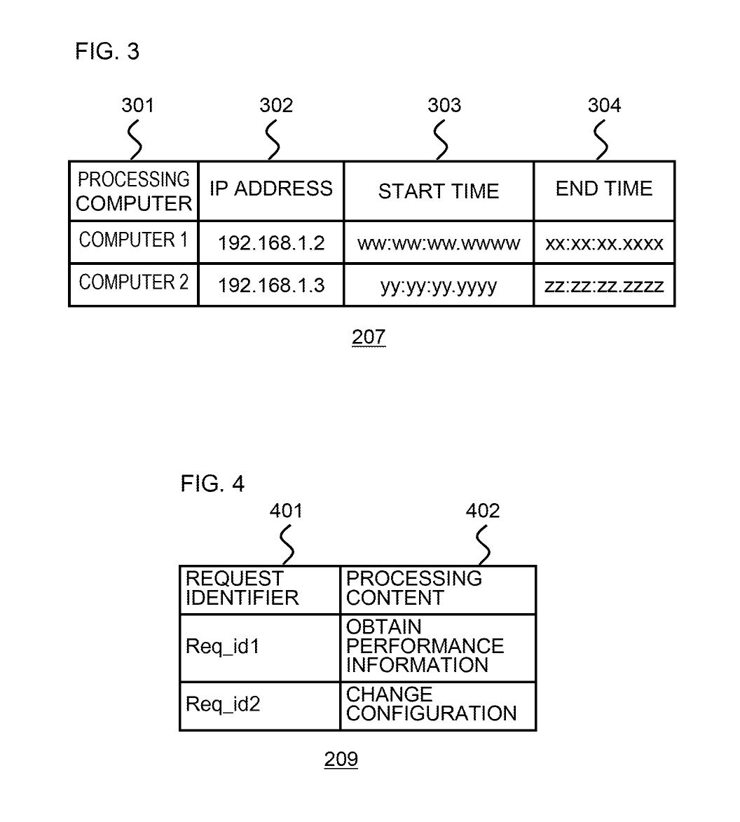

FIG. 3 illustrates an example of the management function schedule table 207 in Embodiment 1. The management function schedule table 207 at least has an identifier 301 of each processing computer 211, and a start time 303 and an end time 304 of a management function processing time in each processing computer 211. Further, in a case where each processing computer 211 and the management computer 201 are connected by an Internet Protocol (hereinafter referred to as “IP”) network, then the management function schedule table 207 may have an IP address 302 of each processing computer 211.

FIG. 4 illustrates an example of the result wait queue 209 that the management computer 201 has. The result wait queue 209 is a queue for managing the request to which the result of the processing is not replied from the processing computer 211, after the request transmission program 208 requests the management function processing to the processing computer 211. The result wait queue 209 at least has a request identifier 401 of the management function processing, and a column 402 which indicates a processing content of each request.

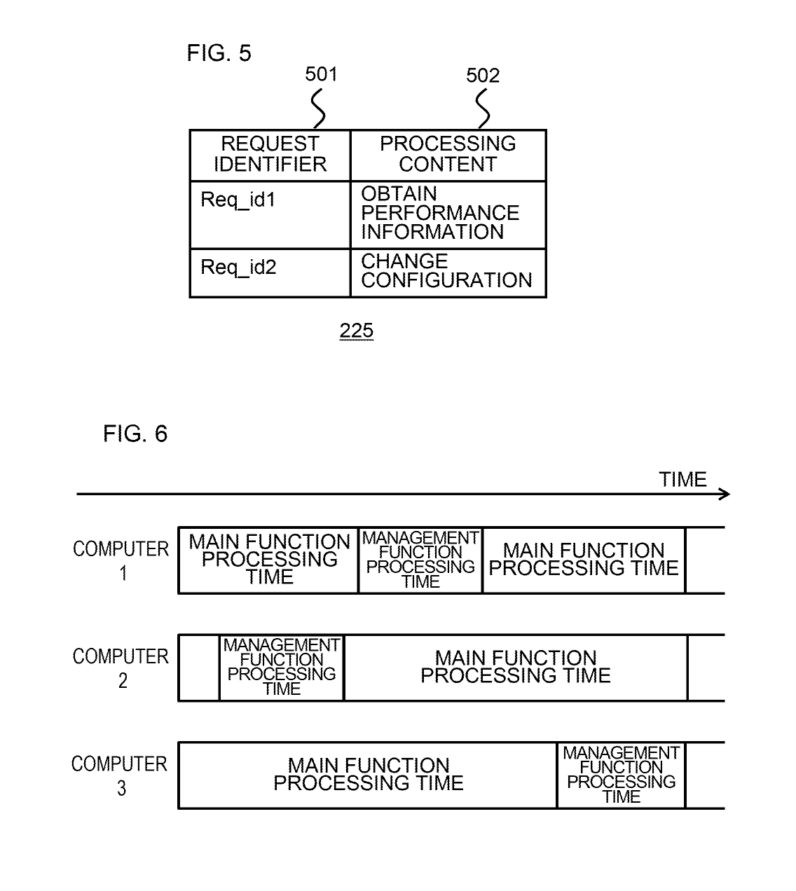

FIG. 5 illustrates an example of the management request queue 225 that the shared computer 220 has. The management request queue 225 is a queue for managing the request to which the processing is not executed, after the request for the management function processing is received by the processing computer 211. The management request queue 225 at least has a request identifier 501 of the management function processing, and a column 502 which indicates a processing content of each request. Here, the management request queue 225 illustrated in FIG. 5 has a same configuration in Embodiment 2 and Embodiment 3 to be explained later.

FIG. 6 illustrates that the processing computer 211 processes two functions (the main function and the management function) by time-sharing. A main function processing time is a time in which a function processing program as a main purpose of the processing computer 211 (the main function processing program 218) is operating. As a processing content of the main function processing program 218, for example in a case where the processing computer 211 is a storage device, an I/O processing of the data corresponds thereto. Further, in a case where the processing computer 211 is a computer for scientific computing, then an arithmetic processing for the scientific computing corresponds to the processing content.

A management function processing time is a time in which a program for management of the processing computer 211 (the management function processing program 216) is operating. As a processing content of the management function processing program 216, for example, a communication processing with the management computer 201, a processing for changing a configuration of the processing computer 211, a processing for changing an account of an administrator, and the like, correspond thereto.

Each processing computer 211 (computers 1 through 3 in FIG. 6) has different processing time for the two functions that are allocated in a time-sharing matter. By processing the two functions using time-sharing, even when the management request from the management computer 201 is received outside the management function processing time, the management request may be processed, when the next management function processing time arrives.

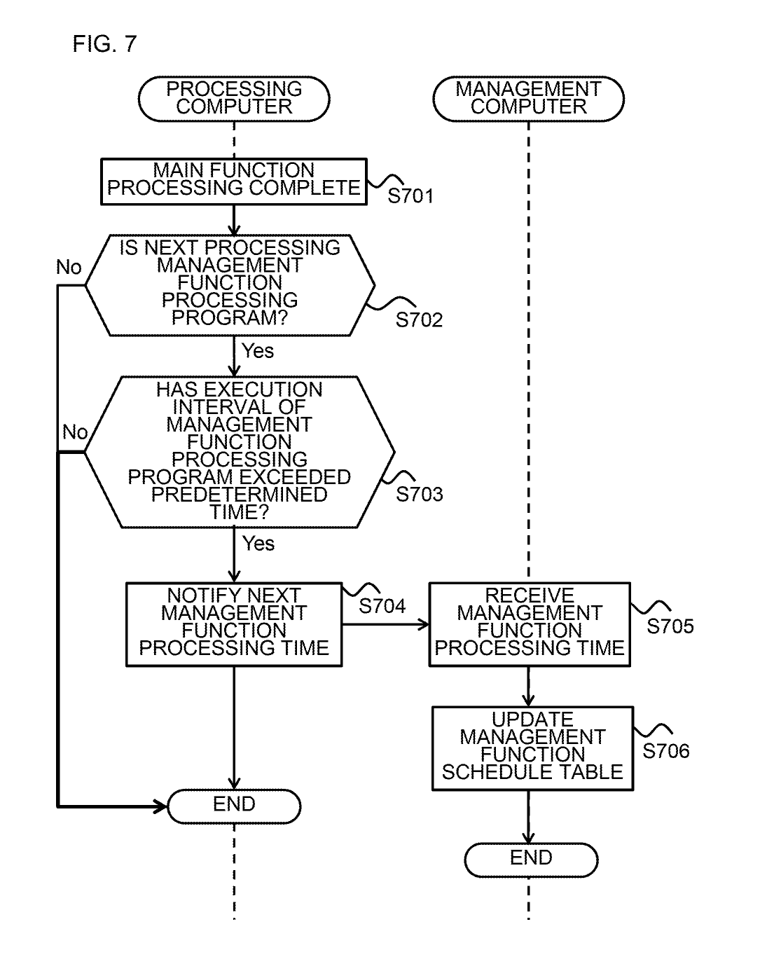

FIG. 7 is a flowchart illustrating a procedure in which the management computer 201 updates the management function schedule table 207, based on a notification from the processing computer 211, in Embodiment 1.

When the main function processing program 218 which the processing computer 211 is executing ends (S701), the main function processing program 218 refers to the scheduler 219, and confirms whether or not the next operating program is the management function processing program 216 (S702).

In a case where the next processing is not the management function processing program 216 (S702: No), then the processing computer 211 ends without performing notification to the management computer 201.

On the other hand, in a case where the next processing is the management function processing program 216 (S702: Yes), then the management function processing program 216 confirms whether or not an executing interval exceeds a predetermined time (S703).

In a case where the executing interval of the management function processing program 216 did not exceed the predetermined time (S703: No), then the processing computer 211 ends without performing a notification to the management computer 201.

On the other hand, in a case where the execution interval of the management function processing program 216 exceeds the predetermined time (S703: Yes), then the main function processing program 218 refers to the scheduler 219 for a time allocated to the management function processing program 216, sets a time in which a changing time of the program is added to the end time of the main function processing program 218 as the start time of the management function processing time, and sets a time in which the time allocated for the management function processing program 216 is added to the start time as the end time of the management function processing time, and notifies the start time and the end time to the management computer 201 (S704). Here, the steps from S702 to S704 may be executed not by the main function processing program 218, but by a notification program not shown.

The management computer 201 receives the notification (S705), and updates, in a row in the management function schedule table 207 which corresponds to the processing computer 211 transmitting the notification, the start time 303 by the start time identified in the received notification, and the end time 304 by the end time identified in the received notification, respectively (S706).

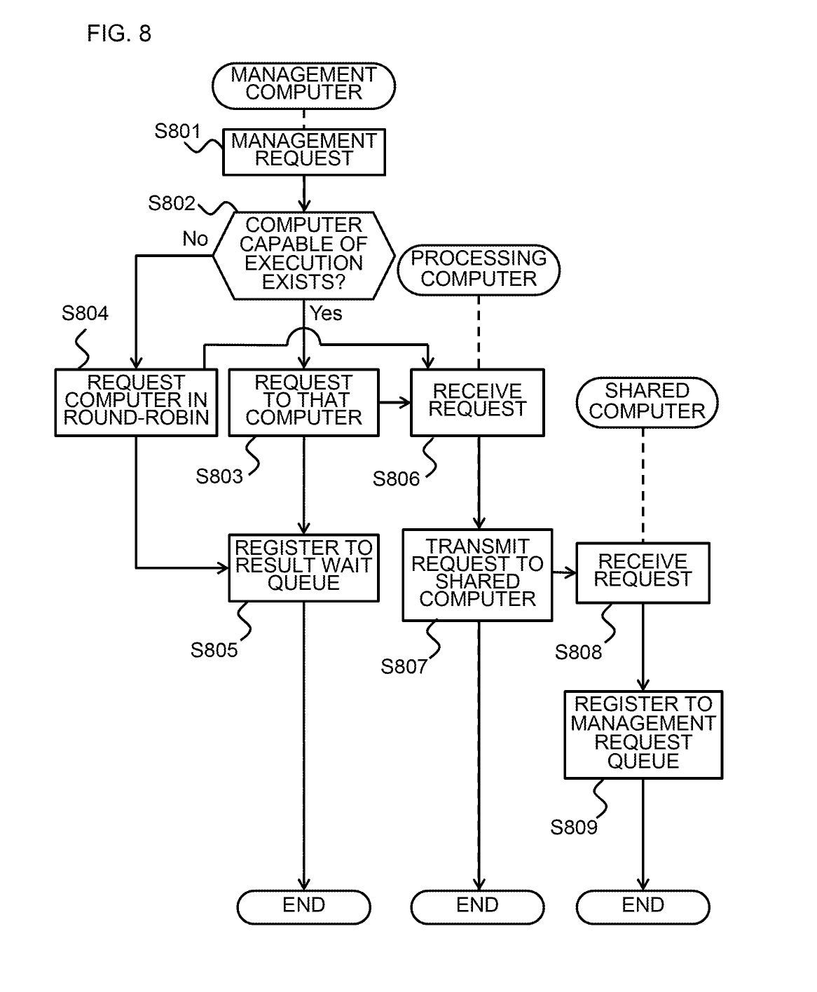

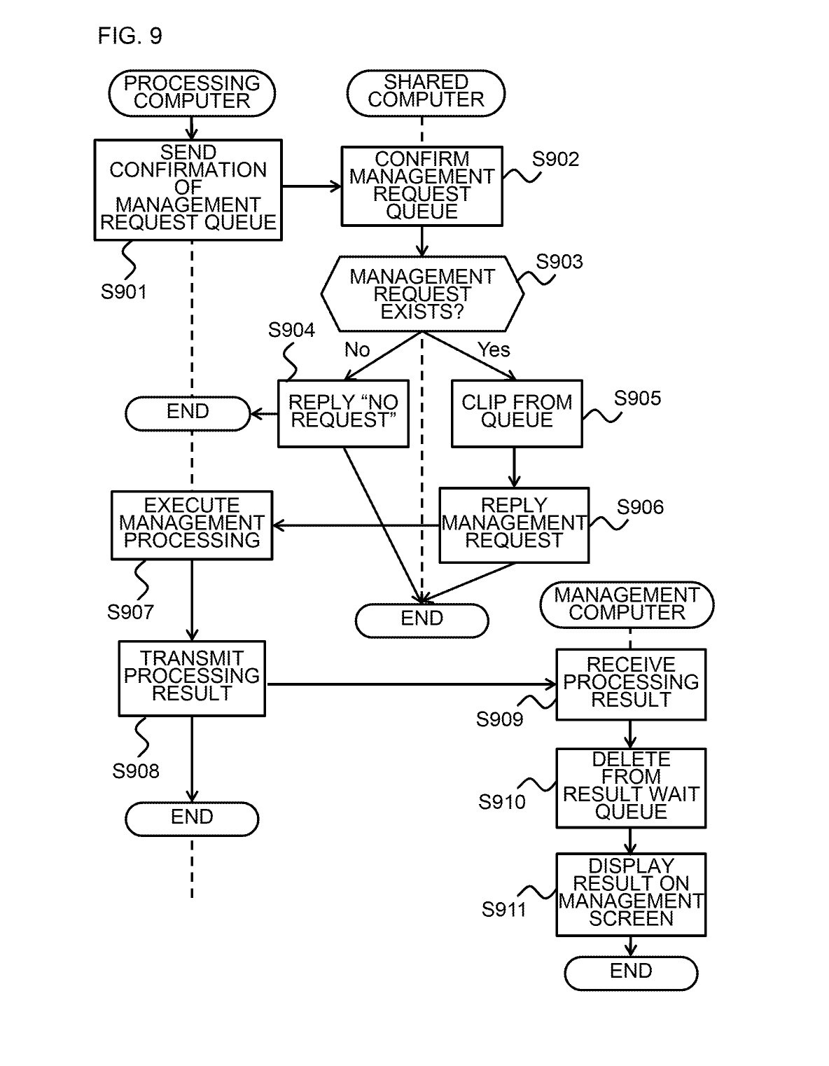

FIG. 8 is a flowchart illustrating a procedure in which the processing computer 211, which received a request for the management function processing from the management computer 201, receives the request and registers the same to the management request queue 225 in the shared computer 220, in Embodiment 1.

First, the management computer 201 receives the request for the management function processing, from a user via the management screen 202 (S801).

Subsequently, the management program 206 checks whether or not there is a processing computer 211 corresponding to a condition that the start time 303 is older than the current time, and the end time 304 is newer than the current time (that is, capable of executing), by referring to the management function schedule table 207 (S802).

In a case where there is no processing computer 211 corresponding to the condition (S802: No), then the management program 206 applies an identifier with respect to the management function processing, and requests the management function processing to an arbitral processing computer 211 (S804). As a selecting algorithm of the arbitral processing computer 211, a round-robin is suitable. On the other hand, in a case where there is the processing computer 211 corresponding to the condition (S802: Yes), then the management program 206 applies the identifier with respect to the management function processing, and requests the management function processing by executing the request transmission program 208 to the processing computer 211 (S803).

Subsequently, the management program 206 registers the request to the result wait queue 209 (S805). Specifically, an entry in which the identifier generated in S803 or S804 is stored in the request identifier 401, and the content of the management function processing is stored in the column 402, is newly generated, and the same is added to the result wait queue 209.

The processing computer 211 receives the request from the management program 206 in the step of S803 or S804 (S806), executes the queue management program 217, and transmits the request to the shared computer 220 (S807).

Subsequently, the shared computer 220 receives the request (S808), and registers the request to the management request queue 225 via the transmitting/receiving function 224 (S809). Specifically, an entry in which the identifier generated in S803 or S804 is stored in the request identifier 501, and the content of the management function processing is stored in the column 502, is newly generated, and the same is added and recorded to the management request queue 225.

FIG. 9 is a flowchart illustrating the procedure, in Embodiment 1, in which the processing computer 211 executes the management function processing registered in the management request queue 225 of the shared computer 220.

First, the processing computer 221 in which the management function processing time arrived, executes the management function processing program 216. The management function processing program 216 executes the queue management program 217, and confirms whether or not an unprocessed entry exists in the management request queue 225, to the shared computer 220 (S901).

Subsequently, the shared computer 220 confirms the management request queue 225 (S902), and determines the existence of the unprocessed processing request (entry) (S903). In a case where no unprocessed entry exists (S903: No), then the shared computer 220 replies accordingly (“no request”) to the processing computer 211 via the transmitting/receiving function 224 (S904), and the processing computer 211 starts the main function processing program 218 without actuating the management function processing program 216.

On the other hand, in a case where the unprocessed entry exists (S903: Yes), then the shared computer 220 clips the entry from the management request queue 225 (S905), and replies the content of the entry to the processing computer 211 via the transmitting/receiving function 224 (S906).

The management function processing program 216 of the processing computer 211 receiving the content of the entry executes the processing content 502 stored in the entry (S907), and transmits the identifier 501 of the processing and the result of the processing to the management computer 201 (S908).

The management computer 201 receives the result of the processing with the result reception program 210, and executes the management program 206 (S909). The management program 206 searches for the entry corresponding to the identifier 501 in the result wait queue 209, and deletes the entry (S910).

Lastly, the management program 206 displays the result of the processing to the management screen 202 (S911).

With the procedure explained above, it becomes possible to process the management function requested by the user with the processing computer 211, and the user may confirm the processing result. As is explained in FIG. 6, even when the processing computer 211 receives the management request during the main function processing time, the processing computer 211 may execute the management function processing program 216. Therefore, it is not necessary for the management computer 201 to strictly manage the schedule of the processing computer 211, so that a specification of resources such as a CPU (Central Processing Unit) and RAM (Random Access Memory) and the like that are required to the management computer 201 may be suppressed low.

### Embodiment 2

Embodiment 2 is an embodiment in which, in addition to Embodiment 1, each processing computer 211 has a mode, and each processing computer 211 changes the schedule of the processing which is implemented based on the mode, and the management computer 201 decides the processing computer 211 performing the request for the management function processing taking the mode into consideration.

The memory 215 of the processing computer 211 in Embodiment 2 has, in addition to the programs that the memory 215 in Embodiment 1 has, a main function load monitor and a mode switch program.

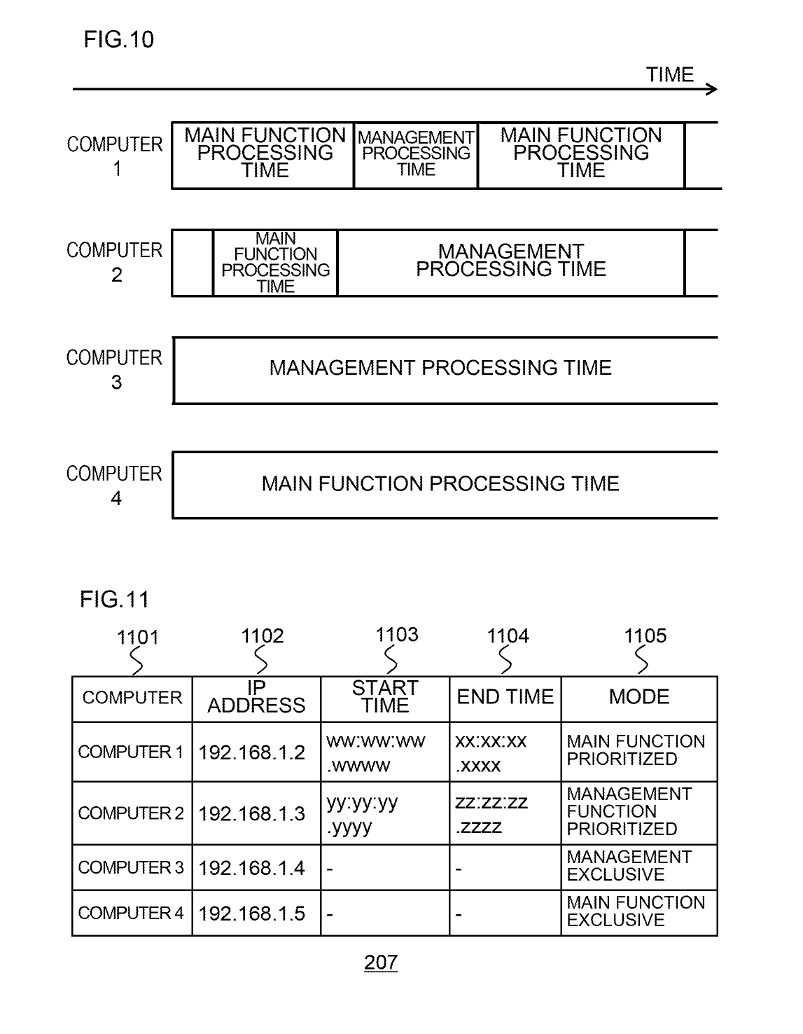

FIG. 10 is a block diagram illustrating a relation between a mode of the processing computer 211 and a time-sharing processing mode in Embodiment 2. The computer 1 indicates that the computer is in a main function prioritized mode, and in this mode, the scheduler 219 allocates a longer time for the main function processing time compared to the management function processing time, and makes the CPU 213 execute the same. The computer 2 indicates that the computer is in a management prioritized mode, and in this mode, the scheduler 219 allocates a longer time for the management function processing time compared to the main function processing time, and makes the CPU 213 execute the same. The computer 3 indicates that it is in a management exclusive mode, and in this mode, the scheduler 219 allocates the management function processing time only, and makes the CPU 213 execute the same. The computer 4 indicates that it is in a main function exclusive mode, and in this mode, the scheduler 219 allocates the main function processing time only, and makes the CPU 213 execute the same. Here, all these modes are examples, and the scheduler 219 of each processing computer 211 may not have all the modes, or may have other modes.

FIG. 11 illustrates an example of the management function schedule table 207 in Embodiment 2. In Embodiment 2, in addition to columns 1101 through 1104 corresponding to the management function schedule table 207 of Embodiment 1 illustrated in FIG. 3, the management function schedule table 207 has a column 1105 showing a mode of each computer. Further, for a start time 1103 and an end time 1104 corresponding to the computer of the management exclusive mode or the main function exclusive mode (the computer 3 and the computer 4), there is no need to store the data in the table, so that a hyphen is input thereto in FIG. 11 as an example.

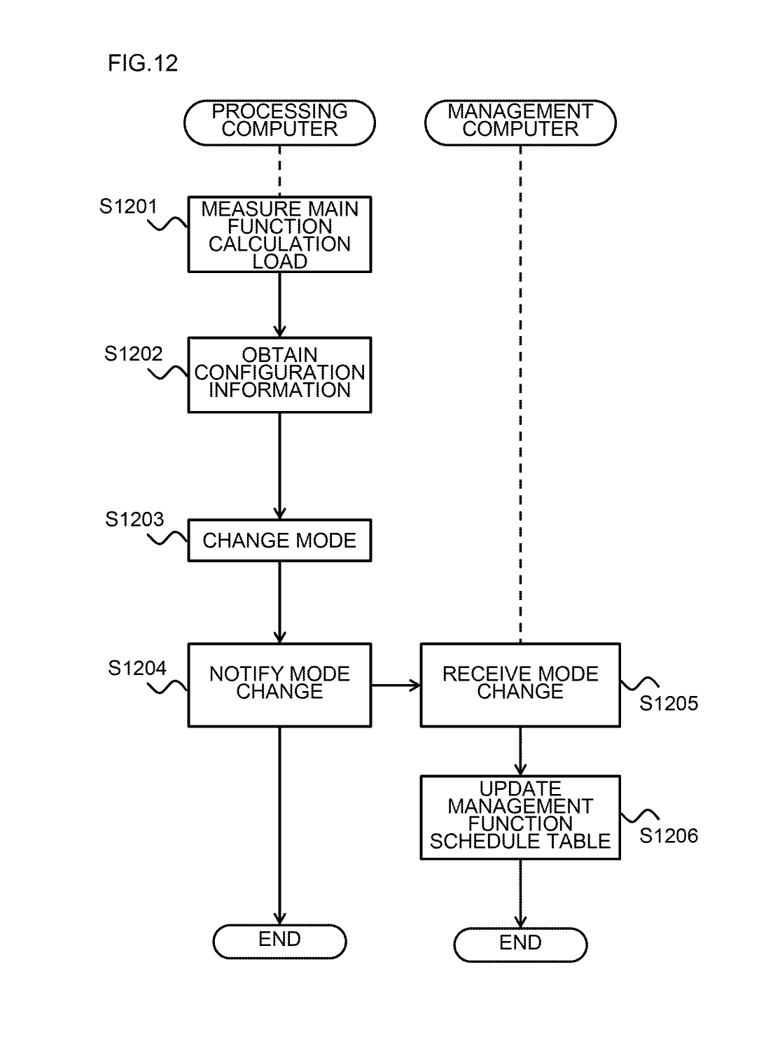

FIG. 12 illustrates a flow chart in which the processing computer 211 notifies the changed content to the management computer 201, and the management computer 201 updates the management function schedule table 207, when the processing computer 211 changed its mode.

First, a main function load monitor of the processing computer 211 measures a load of the main function processing (S1201). As an example of a measurement method, a method of measuring a length of a queue of the request that the main function must process, or a method of predicting an amount of the request that the main function must process in the future from a history of past requests, may be given.

Subsequently, the mode switch program studies the configuration of the processing computer 211 (S1202). For example, in a case where the processing computer 211 is a storage device, and if no path for accessing a storage area for storing data of users is allocated to the processing compute 211, then no I/O processing of the data with respect to the processing computer 211 is generated. Therefore, it may be set to the management exclusive mode.

Subsequently, the mode switch program changes the mode based on the measurement result of the load of the main function processing and the study result of the configuration, and notifies the same to the scheduler 219 (S1203).

Subsequently, the mode switch program notifies the mode after change to the management computer 201 (S1204).

The management computer 201 receives this notification (S1205), and executes the management program 206. Of the management function schedule table 207, the management program 206 updates a mode 1105 of the row corresponding to the processing computer 211, to the mode notified from the processing computer 211 (S1206).

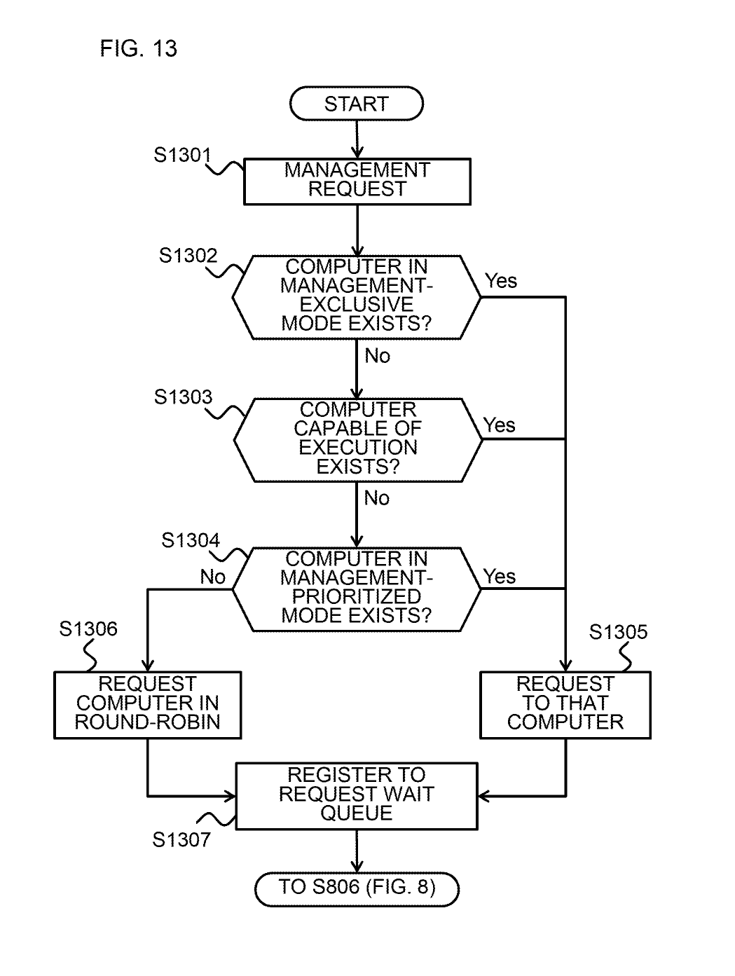

FIG. 13 illustrates a flowchart in which the management program 206 requests the management function processing to the processing computer 211, based on the management function schedule table 207 having the mode 1105.

First, the management computer 201 receives the request for the management function processing from the user via the management screen 202 (S1301).

Subsequently, the management computer 201 activates the management program 206. The management program 206 checks whether there is the processing compute 211 of the management exclusive mode, by referring to the management function schedule table 207 (S1302). In a case where there is the processing computer 211 of the management exclusive mode (S1302: Yes), then the management program 206 applies an identifier with respect to the management function processing, and requests the management function processing to the processing computer 211 (S1305).

In a case where there is no processing computer 211 of the management exclusive mode (S1302: No), the management program 206 checks whether there is a processing computer 211 corresponding to a condition that the start time 303 is older than the current time and the end time 304 is newer than the current time (that is, capable of executing), by referring to the management function schedule table 207 (S1303). In a case where there is the processing computer 211 corresponding to the condition (S1303: Yes), then the management program 206 applies the identifier with respect to the management function processing, and requests the management function processing to the processing computer 211 (S1305).

In a case where there is no processing computer 211 corresponding to the condition (S1303: No), then the management program 206 checks whether there is the processing computer 211 of the management prioritized mode, by referring to the management function schedule table 207 (S1304). If there is the processing computer 211 of the management prioritized mode (S1304: Yes), then the management program 206 applies the identifier with respect to the management function processing, and requests the management function processing to the processing computer 211 (S1305).

In a case where there is no processing computer 211 of the management prioritized mode (S1304: No), then the management program 206 applies the identifier with respect to the management function processing, and requests the management function processing to an arbitral processing computer 211 (S1306). As a selecting algorithm of the arbitral processing computer 211, a round-robin is suitable.

Subsequently, the processing computer 211 executes the management function processing program 216, and the management function processing program 216 registers the request to the result wait queue 209 (S1307).

The processing after this step is the same as the processing after S806 illustrated in the flow chart of FIG. 8 and the processing of FIG. 9 of Embodiment 1.

With the above-mentioned procedure, it becomes possible to process the management function requested by the user with the processing computer 211, and the user may confirm the processing result by the management screen 202 of the management computer 201. The management computer 201 requests the management function processing preferentially to the processing computer 211 of the management exclusive mode or the management prioritized mode, so that it becomes possible to shorten the processing time of the management function processing with respect to the user.

Further, in the above, explanation is given on a case where both the management exclusive mode and the management prioritized mode are provided. However, it is not always necessary to have both modes, and the present invention may be applied to a case where only one of the modes is provided. In a case where only the management exclusive mode is provided, the determination processing of S1304 of FIG. 13 will be omitted, and in a case where only the management prioritized mode is provided, the determination processing of S1302 of FIG. 13 will be omitted.

### Embodiment 3

Embodiment 3 is an embodiment in which, in addition to Embodiment 1 or Embodiment 2, the processing computer 211 which received the request for the management function processing executes the management function processing, without intervention of the management request queue 225.

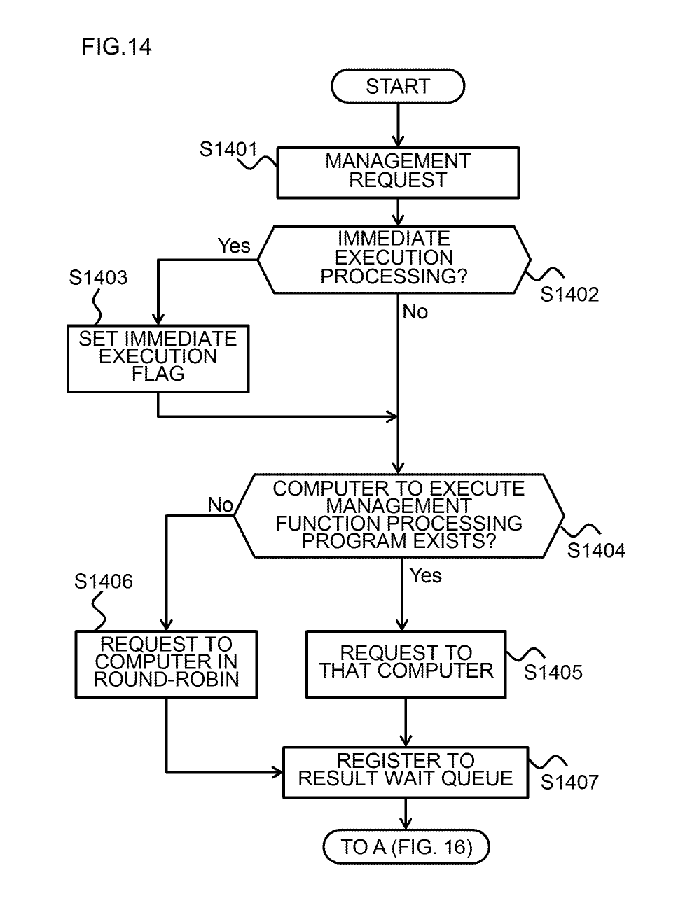

FIG. 14 through FIG. 16 illustrate the processing procedure (flowchart) of the management computer 201 and the processing computer 211, in a case where the user requests an immediate execution of the management function processing.

FIG. 14 is a flowchart illustrating a processing procedure for executing the above-mentioned processing, in addition to Embodiment 1.

First, the management computer 201 receives the request for the management function processing from the user via the management screen 202 (S1401).

Subsequently, the management computer 201 activates the management program 206, and the management program 206 determines whether or not the request for the management function processing is a request for the immediate execution (S1402). Whether or not the request is the request for the immediate execution may be designated by the user using the management screen 202 in S1401, or may be determined by the management program 206 based on the content of the management function processing.

For example, in a set-up operation for starting operation of the processing computer 211, it is not necessary for the processing computer 211 to execute the main function processing program 218. Therefore, by the administrator designating the immediate execution, it becomes possible to shorten the processing time of the management function necessary for the set-up operation. Further, in a case where a malfunction occurred in the processing computer 211, a configuration may be adopted in which the management program 206 designates the immediate execution to a process of obtaining a log recording information of the malfunction and the like, in order to achieve prompt recovery from the malfunction by shortening the processing time.

In a case where the request is the request for the immediate execution (S1402: Yes), then the management program 206 adds a flag indicating the immediate execution to the request (S1403). In a case where it is not the request for the immediate execution (S1402: No), then the process immediately proceeds to the next step S1404.

Subsequently, the management program 206 checks whether there is a processing computer 211 corresponding to a condition that the start time 303 is older than the current time and the end time 304 is newer than the current time (that is, capable of executing), by referring to the management function schedule table 207 (S1404).

In a case where there is no processing computer 211 corresponding to the condition (S1404: No), then the management program 206 applies an identifier with respect to the management function processing, and requests the management function processing to an arbitral processing computer 211 (S1406). As a selecting algorithm of the arbitral processing computer 211, a round-robin is suitable. In a case where there is the processing computer 211 corresponding to the condition (S1404: Yes), then the management program 206 applies the identifier with respect to the management function processing, and requests the management function processing to the processing computer 211 (S1405).

Subsequently, the processing computer 211 registers the request to the result wait queue 209 (S1407). The processing after this step will be explained later using FIG. 16.

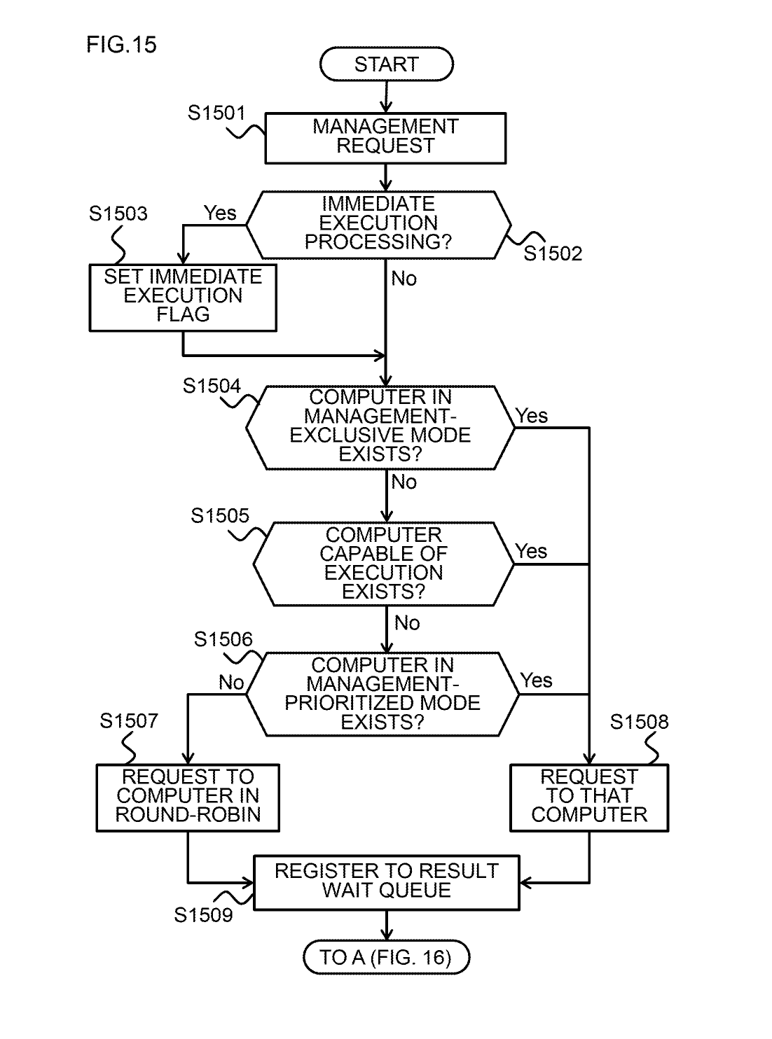

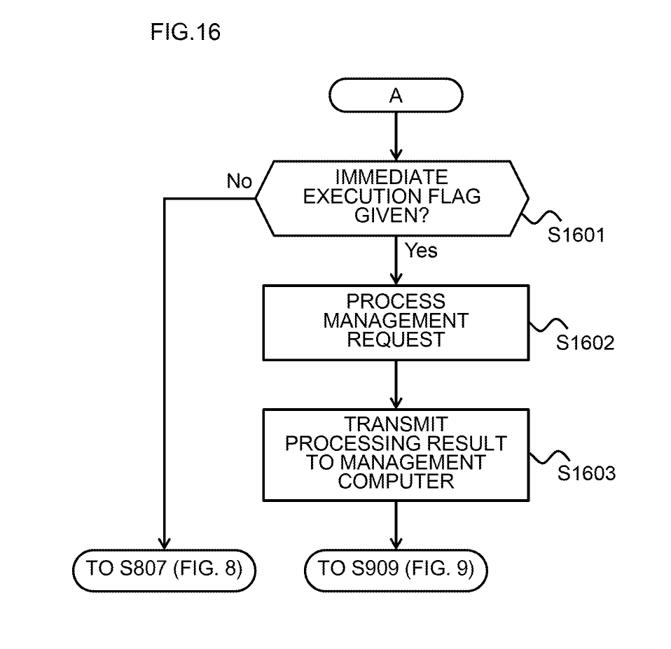

FIG. 15 is a flowchart illustrating the processing procedure in which the processing computer 211 receiving the request for the management function processing executes the management function processing, without intervention of the management request queue 225, in addition to Embodiment 2.

First, the management computer 201 receives the request for the management function processing from the user via the management screen 202 (S1501).

The management computer 201 activates the management program 206, and the management program 206 determines whether or not the earlier request is the request for the immediate execution (S1502). In a case where it is the request for the immediate execution (S1502: Yes), then the management program 206 adds the flag indicating the immediate execution to the request (S1503).

Subsequently, the management program 206 checks whether there is the processing computer 211 of the management exclusive mode, by referring to the management function schedule table 207 (S1504). In a case where there is the processing computer 211 of the management exclusive mode (S1504: Yes), then the management program 206 applies an identifier with respect to the management function processing, and requests the management function processing to the processing computer 211 (S1508).

In a case where there is no processing computer 211 of the management exclusive mode (S1504: No), then the management program 206 checks whether there is a processing computer 211 corresponding to a condition that the start time 303 is older than the current time and the end time 304 is newer than the current time (that is, capable of executing), by referring to the management function schedule table 207 (S1505). In a case where there is the processing computer 211 corresponding to the condition (S1505: Yes), then the management program 206 applies the identifier with respect to the management function processing, and requests the management function processing to the processing computer 211 (S1508).

In a case where there is no processing computer 211 corresponding to the condition (S1505: No), then the management program 206 checks whether there is the processing computer 211 of the management prioritized mode, by referring to the management function schedule table 207 (S1506). In a case where there is the processing computer 211 of the management prioritized mode (S1506: Yes), then the management program 206 applies the identifier with respect to the management function processing, and requests the management function processing to the processing computer 211 (S1508).

In a case where there is no processing computer of the management prioritized mode (S1508: No), then the management program 206 applies the identifier with respect to the management function processing, and requests the management function processing to an arbitral processing computer 211 (S1507). As a selecting algorithm of the arbitral processing computer 211, a round-robin is suitable.

Subsequently, the processing computer 211 executes the management function processing program 216, and the management function processing program 216 registers the request from S1507 or S1508 to the result wait queue 209 (S1509).

Further, as is shown at the end of the explanation of Embodiment 2, the present invention is applicable to a case where only one mode of the management exclusive mode or the management prioritized mode is provided. In a case where only the management exclusive mode is provided, the determination processing of S1506 will be omitted, and in a case where only the management prioritized mode is provided, the determination processing of S1504 will be omitted.

After the processing of S1407 (FIG. 14) or S1509 (FIG. 15), the processing will be those illustrated in the flowchart of FIG. 16. The management function processing program 216 of the processing computer 211 receiving the request from the management program 206, confirms whether or not the immediate execution flag is applied to the request from S1407 or S1509 (S1601).

In a case where the immediate execution flag is applied (S1601: Yes), then the management function processing program 216 executes the processing content requested (S1602), and transmits the identifier 401 and the result of the processing to the management computer 201 (S1603). The processing after this step is similar to the processing after S909 illustrated in the flowchart of FIG. 9 in Embodiment 1. That is, in a case where the immediate execution flag is applied, the management function processing program 216 of the processing computer 211 executes the processing content requested, without activating the queue management program 217 and the main function processing program 218. By doing so, the request of the management function processing with the immediate execution flag applied is not stored in the management request queue 225.

In a case where the immediate execution flag is not applied (S1601: No), then the processing after this step is similar to the processing after S807 illustrated in the flowchart of FIG. 8 in Embodiment 1.

With the procedure explained above, it becomes possible to immediately execute the management function processing, and compared to the case of Embodiment 1 or Embodiment 2, the use may recognize the result of the processing faster. Therefore, with respect to the management request having urgency, such as the set-up operation upon starting operation or the countermeasures to malfunction, it becomes possible to achieve even faster correspondence.

### REFERENCE SIGNS LIST

101, 201 Management computer
202 Management screen
203 CPU
204 Interface
205 Memory
206 Management program
102, 207 Management function schedule table
208 Request transmission program
209 Request wait queue
210 Request reception program
103, 211 Processing computer
212 Interface
213 CPU
214 Interface
215 Memory
105, 216 Management function processing program
217 Queue management program
104, 218 Main function processing program
219 Scheduler
220 Shared computer
221 Interface
222 CPU
223 Memory
224 Transmitting/receiving function
225 Management request queue

1. (canceled)

2. A computer system comprising:
a plurality of processing computers having a first processing means for executing a main function processing and a second processing means for executing a management function processing which is requested from a management computer, and
the management computer having a storage area for storing a start time and an end time of an operation of the second processing means of the plurality of the processing computers;
wherein the plurality of the processing computers notify the start time and the end time of the operation of the second processing means to the management computer, and
the management computer updates the start time and the end time that are stored in the storage area to the notified start time and the end time, and requests the management function processing to the processing computer which has the second processing means in which a time requesting the management function processing falls within a time frame of the start time and the end time that are stored in the storage area,
further comprising a shared computer connected to the plurality of the processing computers,
wherein the shared computer stores the request for the management function processing that the plurality of the processing computers receive from the management computer, and
the plurality of the processing computers obtain the request of the management function processing that the shared computer stores and execute the same with the second processing means possessed by the processing computers.

3. The computer system according to claim 2,
wherein at least one of the plurality of the processing computers has a setting means for setting a mode for prioritizing the processing by the first processing means or a mode for prioritizing the processing by the second processing means, and
the management computer stores the mode of the plurality of the processing computers in the storage area, updates the mode stored in the storage area upon receiving a notification of a mode setting by the setting means, and requests the management function processing to the processing computer in the mode for prioritizing the processing by the second processing means.

4. The computer system according to claim 3,
wherein at least one of the plurality of the processing computers has a mode making the processing by the second processing means exclusive, and
the management computer requests the management function processing with top priority to the processing computer in the mode making the processing by the second processing means exclusive.

5. The computer system according to claim 4,
wherein the plurality of the processing computers change the mode, based on a load amount which must be processed as the main function processing, or a configuration of the processing computer.

6. The computer system according to claim 2,
wherein, in a case where the request for the management function processing received from the management computer designates an immediate execution, the plurality of the processing computers execute the second processing means without activating the first processing means.

7. The computer system according to claim 2,
wherein, in a case where the request of the management function processing received from the management computer designates an immediate execution, the plurality of the processing computers execute the second processing means, without storing the request in the shared computer, and without activating the first processing means.

8. (canceled)

9. A control method of a computer system configured from
a plurality of processing computers having a first processing means for executing a main function processing and a second processing means for executing a management function processing which is requested from a management computer, and
the management computer having a storage area for storing a start time and an end time of an operation of the second processing means of the plurality of the processing computers;
wherein the plurality of the processing computers have a first step of notifying the start time and the end time of the operation of the second processing means to the management computer, and
the management computer has
a second step of updating the start time and the end time that are stored in the storage area to the start time and the end time notified in the first step,
a third step of determining whether or not the time requesting the management function processing falls within a time frame of the start time and the end time that are stored in the storage area, and
a fourth step of requesting the management function processing to the processing computer having the second processing means that is determined to fall within the time frame in the third step,
wherein the computer system further comprises a shared computer connected to the plurality of the processing computers,
the shared computer has a fifth step of storing the request for the management function processing that the plurality of the processing computers receive from the management computer, and
the plurality of the processing computers have a sixth step of acquiring the request for the management function processing that the shared computer stores and execute the same with the second processing means possessed by the processing computer.

10. The control method of the computer system according to claim 9,
wherein at least one of the plurality of the processing computers has a setting step of setting a mode for prioritizing the processing by the first processing means or a mode for prioritizing the processing by the second processing means, and
the management computer has
a storing step of storing the mode of the plurality of the processing computers in the storage area,
an updating step of updating the mode stored in the storage area upon receiving a notification of a mode setting by the setting mode, and
a processing requesting step of requesting the management function processing to the processing computer in the mode for prioritizing the processing by the second processing means.

11. The control method of the computer system according to claim 9,
wherein at least one of the plurality of the processing computers has a changing step of changing a mode for prioritizing the processing by the first processing means, a mode for prioritizing the processing by the second processing means, and a mode for making the processing by the second processing means exclusive, and
the management computer has
an updating step of updating the mode stored in the storage area upon receiving a notification of a mode change by the changing step,
a first processing requesting step of requesting the management processing function with top priority to the processing computer in the mode making the processing by the second processing means exclusive, and
a second processing requesting step of requesting the management function processing also to the processing computer in the mode for prioritizing the processing by the second processing means.

12. The control method of the computer system according to claim 11,
wherein the changing step changes the mode, based on a load amount which must be processed as the main function processing, or a configuration of the processing computer.

13. The control method of the computer system according to claim 9,
wherein the plurality of the processing computers has an immediate executing step of executing the second processing means without activating the first processing means, upon receiving the request from the management computer, in a case where the request for the management function processing designates an immediate execution.

14. The control method of the computer system according to claim 9,
wherein the plurality of the processing computers has an immediate executing step of executing the second processing means without storing the request in the shared computer and without activating the first processing means, upon receiving the request from the management computer, in a case where the request for the management function processing designates an immediate execution.
